(19) United States
(12) Patent Application Publication
(10) Pub. No.: US 2007/0020303 A1
(43) Pub. Date: Jan. 25, 2007

(54) Crow repelling cloth

(76) Inventor: Kazuhiko Taniguchi, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/185,839

(22) Filed: Jul. 21, 2005

(51) Int. Cl. A01N 25/00

(52) U.S. Cl. 424/405

(57) ABSTRACT

In order to provide a crow repelling cloth for keeping off crows at a low cost, a cloth is impregnated with calcined fine powder of highly pure silica-titanium together with a resin so as to release minus ions. The cloth is colored in yellow or black. The cloth can be in the form of a ribbon, a net, a tape or the like depending upon the use.

### BACKGROUND OF THE INVENTION

1. Field of the Invention

This invention relates to a cloth so treated as to be evaded by crows for preventing and keep off the crows.

2. Related Art

Garbage from the households is placed at a predetermined place and is picked up by a garbage truck circulating regularly. Until picked up by the garbage truck, however, the garbage is left as it is, thereby allowing crows to scatter the garbage around. In recent years, quite a lot of crows are flocking together on the garbage and a countermeasure against the crows has become problem particularly in urban areas. A variety of countermeasures have been taken heretofore, however, without sufficient effects and being forced to have a contest of wits with the crows.

A most general method employed heretofore is to use a net “a” as shown in FIG. 5. A heap of garbage sacks “b”, “b”, —containing garbage is covered with the net “a”, and weights of stones “c”, “c”, —are arranged along the circumference of the net “a” for the net not to be wound up. However, the crows accustomed to the net peck the garbage through the meshes of the net and through the other gaps to scatter the garbage. Therefore, the streets are littered with garbage scattered from the heaps of garbage on the roadside emitting offensive odor, impairing not only fine view of the town but also hygienic environment.

In an attempt to improve the net, therefore, JP-A-2005-8403 disdoses “Trash net using red pepper” obtained by applying or pasting a red pepper or a component thereof onto the trash net, or by attaching articles onto which the pepper or the component thereof is applied or pasted to the peripheries of the net. However, these nets are not only expensive to produce but also are accompanied by a problem in that the effective components extinguish with the passage of time to no longer exhibit the effect.

JP-A-2003-284481 discloses “Net for preventing damage caused by bird” consisting of a monochromatic net body without pattern, and knitted yarns having a gold color visually forming a pattern of net together with green or blue color of the net body and knitted to the net body forming wave-like swellings. This net, however, is expensive to produce.

What are damaged by the crows is not limited to garbage but is orchards in rural areas. That is, the crows peck the matured fruits of the orchards to spoil them. The crows damage matured vegetables on the fields of the farmers too. Therefore, there have been proposed a method of stretching transparent yarns to keep the crows off, as well as “Method for repelling bird and repelling device” as disclosed in JP-A-11-215946 by supporting at least the one end of an artificial or a natural wire material having a coil shape at an object on the ground or a floating object in air so that the coil-shaped wire material can swing or move due to wind for repelling the birds. According to the above method and device, however, the yarns must be stretched maintaining a narrow gap requiring laborious work. Besides, this method may be effective for preventing the crows to approach flying but is not effective for preventing the crows to approach walking.

### SUMMARY OF THE INVENTION

It is therefore an object of this invention to provide a crow repelling cloth for keeping off crows at a low cost by solving the problems inherent in the above prior art.

In order to achieve the above object, this invention provides a crow repelling cloth for keeping off crows, obtained by impregnating the cloth with a calcined fine powder of highly pure silica-titanium together with a resin so as to release minus ions.

The present inventors have learned through experiments that the crows hate minus ions and keep off, and have come up with the idea of so treating the cloth as to release minus ions. The beta waves transform themselves into minus ions after having released electrons. The wavelength in the form of minus ions form a barrier of space of a distance of about one meter releasing minus ions at all times. Far infrared rays are also emitted together with the minus ions. As means for generating minus ions, there is prepared a solution by mixing a calcined fine powder of highly pure silica-titanium with a resin and water, and the cloth is immersed therein with stirring so as to be impregnated therewith.

The inventors have further tested various colors that the crows may hate or evade and have learned that the crows hate and evade “yellow color” and “black color”. Namely, the inventors have prepared cloths of white, black, yellow, red, green, blue, etc. and have placed feeds around these cloths. As a result, “black” and “yellow” cloths have kept the crows off. Other colors are not effective for keeping off the crows so that they approach coveting the feeds. It is, therefore, desired that the cloth be produced in yellow or black color.

The cloth may be in the form of a ribbon that can be tied to twigs or branches of a fruit tree to prevent the crows from approaching the fruit trees. The ribbons can further be tied to slip-preventing fittings on the roofing tiles to keep the crows off a roof of a house.

In order to prevent the crows from approaching an orchard, further, the cloth may be formed as a tape for surrounding peripheries of the orchard. To prevent the crows from approaching garbage sacks, further, the cloth may be formed as a net for covering a heap of garbage sacks.

The cloth of the invention emits minus ions forming a barrier of minus ions over a predetermined region, and accordingly crows hate and evade the cloth and wouldn't approach thereto. By using the cloth of yellow or black color that the crows hate, further, there is a further improved effect for keeping off the crows.

The cloth of the invention can be in the form of a ribbon, a tape or a net depending upon the use, and is easily produced at a low cost. The cloth can be used in a variety of ways by, for example, stretching around the field, and there is no limitation on the use thereof.

### BRIEF DESCRIPTION OF THE DRAWING

FIG. 1 is a view schematically illustrating the use of a crow repelling cloth in the form of ribbons according to an embodiment of the invention;

FIG. 2 is a view schematically illustrating another use of the ribbons;

FIG. 3 is a view schematically illustrating the use of the crow repelling cloth in the form of a garbage net according to another embodiment of the invention;

FIG. 4 is a view schematically illustrating the use of the crow repelling cloth in the form of a tape according to a further embodiment of the invention; and

FIG. 5 is a view schematically illustrating the use of conventional garbage net.

### DETAILED DESCRIPTION OF PREFERRED EMBODIMENT

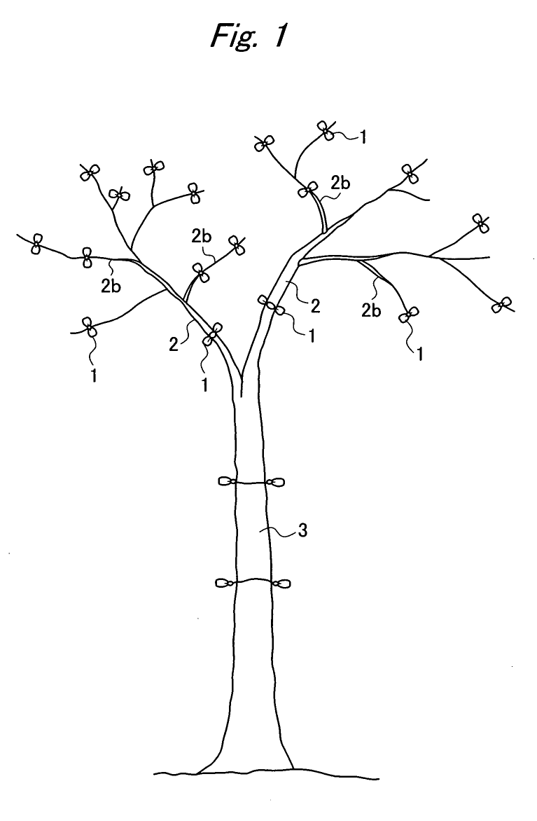

FIG. 1 is a view illustrating the use of a crow repelling cloth in the form of ribbons according to an embodiment of the invention, the ribbons 1, 1, -being tied to a fruit tree such as of apple, orange, pear, etc. The ribbons 1, 1, -are tied to branches 2, 2 -and twigs 2b, 2b -of a fruit tree and are, further, tied to the trunk 3. The ribbons 2 are obtained by cutting a long tape into a suitable length, and are tied to the branches 2, 2 -and twigs 2b, 2b, -.

The ribbons 1, 1, -are obtained by cutting a tape of a constant width into a predetermined length. The tape is dyed in yellow and is, then, treated for releasing minus ions. That is, a highly pure silica-titanium is calcined and fired at a high temperature repetitively several times to produce ceramic form and releases minus ions. The minus ions have a beta wavelength harmless to the human body. The beta waves are transformed into minus ions immediately after released the electrons. The wavelength in the form of minus ions forms a space barrier of a radius of about one meter preventing the crows from entering into this space. The silica-titanium calcined and fired at a high temperature is milled into a fine powder. Water and the fine powdery silica-titanium are mixed into the resin that serves as a binder to prepare a solution thereof in which the tape is immersed with stirring, so that the tape cloth is impregnated therewith.

The ribbon releases minus ions in addition to being dyed in yellow. Therefore, the crows keep off the fruit tree since they hate and evade space where minus ions are released and further hate and evade yellow color. Thus, fruits of the fruit tree can be protected from the crows. In this invention, there is no limitation on the number of branches 2, 2, -and twigs 2b, 2b -to which the ribbons 1, 1, -are bed and on the number of the ribbons 1, 1, -. It is, however, necessary that the ribbons 1, 1, -are so tied that they can be seen distinctly from a distance.

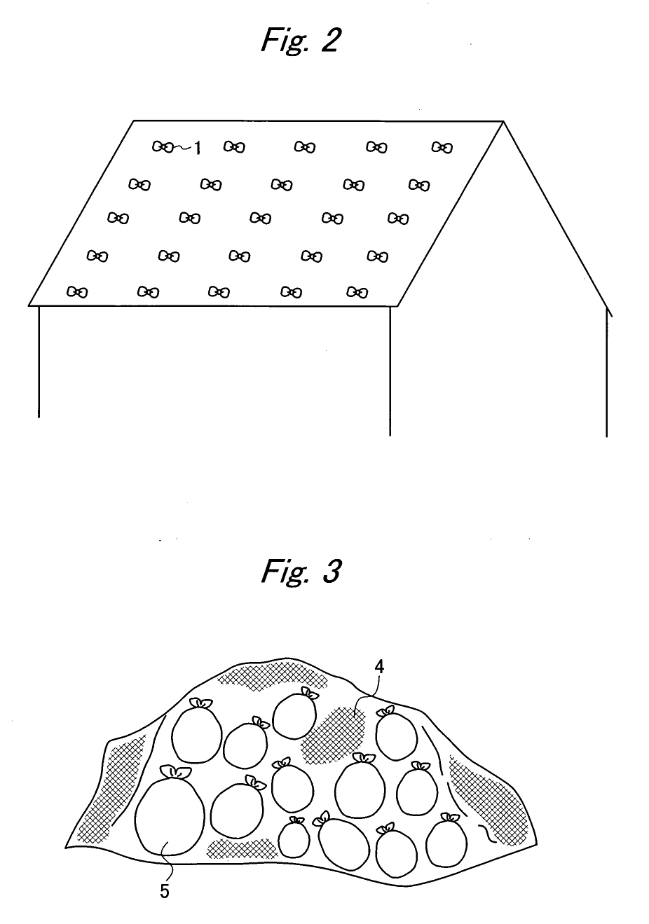

FIG. 2 is a view illustrating another use of the ribbons, wherein the ribbons 1, 1, -are tied to slip-preventing fittings on roofing tiles of a roof. In this case, too, the crows hesitate to approach the roof since they can recognize the yellow ribbons 1, 1, -tied to the roof. Even if having approached dose to the roof, the crows do not perch on the roof due to minus ions released from the ribbons 1, 1, -.

FIG. 3 is a view illustrating the use of a crow repelling cloth in the form of a yellow garbage net according to another embodiment of the invention, the net 4 covering a heap of garbage. Garbage from households is contained in garbage sacks 5, which are heaped on predetermined places and are picked up by a garbage truck. Places where the garbage sacks 5, 5, -are heaped are usually the roadside and corners of a park. A number of garbage sacks 5 are covered by a net 4 in a traditional manner so as to avoid damage caused by the crows.

In this case, the net 4 has been impregnated with a fine powder of a highly pure silica-titanium ore calcined and fired at a high temperature and has also been dyed in yellow. Therefore, the crows keep off the garbage sacks 5, 5, -since they hate and evade space where minus ions are released from the net 4 and, further, hate and evade yellow color.

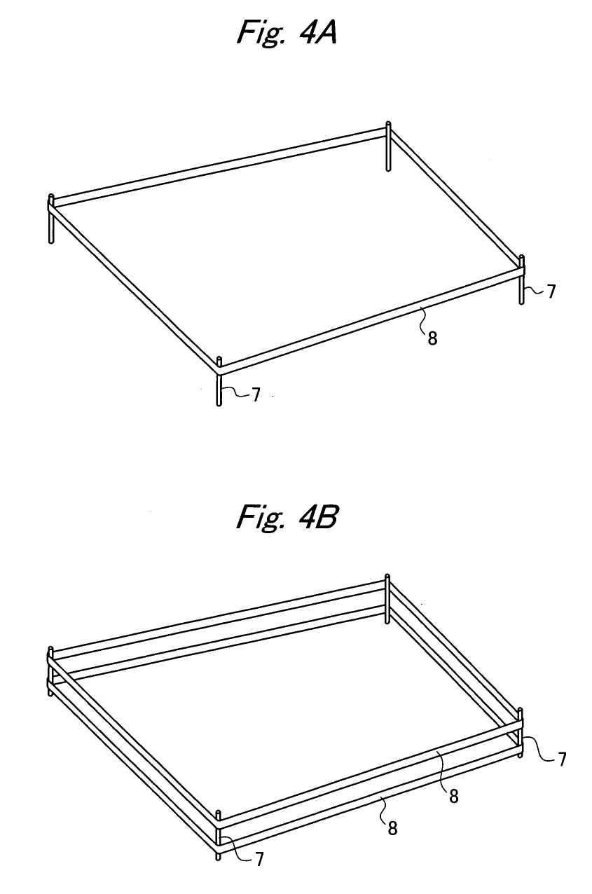

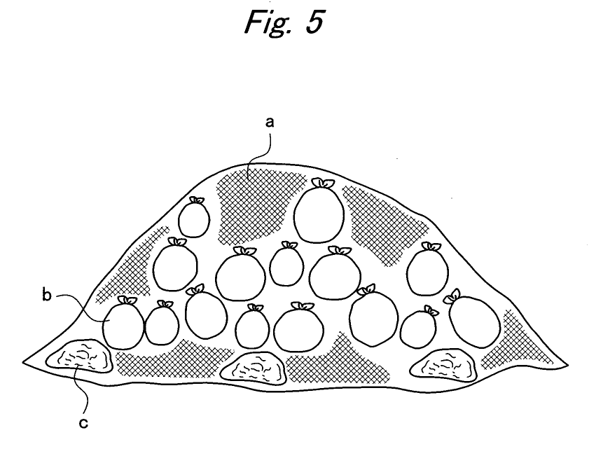

FIGS. 4A and 4B are views illustrating the use of a crow repelling cloth in the form of a yellow tape according to a further embodiment of the invention, surrounding an orchard with a tape 8. While the ribbons 1, 1, -can be tied to the branches 2, 2, -and twigs 2b, 2b, -of the fruit tree as shown in FIG. 1, the whole orchard where a plurality of fruit trees are planted can be surrounded by the tape 8. For this purpose, poles 7, 7, -are erected at the corners of the orchard, and the tape 8 is stretched across the poles 7, 7, -. When the distance is great among the poles 7, 7, -, additional poles 7, 7, -may be provided, so that the tape 8 is not loosened.

Here, the tape 8 has been impregnated with a fine powder of a highly pure silica-titanium calcined and fired at a high temperature and has further been dyed in yellow. Therefore, the crows keep off the tape 8 since they hate and evade space where minus ions are released from the tape 8 and, further, hate and evade yellow color. Even when having approached close to the tape 8, the crows do not enter into the orchard surrounded by the tape 8 forming a barrier of minus ions released from the tape 8. In FIG. 4A, the tape 8 is stretched at the upper ends of the poles 7, 7, -. In FIG. 4B, the tapes 8, 8 are stretched at the upper ends and the lower ends of the poles 7, 7, -.

In the above embodiments, the ribbons, the net and the tapes are dyed in yellow. However, they may be dyed in black that the crows hate and evade in addition to yellow. The crows hate and evade black nets and ribbons and keep off like when the nets and ribbons are dyed in yellow. How to use the nets, ribbons and tapes are not limited to the use of the above embodiments only, as a matter of course.

What is claimed is:

1. A crow repelling cloth for keeping off crows, obtained by impregnating the cloth with a calcined fine powder of highly pure silica-titanium together with a resin so as to release minus ions.

2. A crow repelling cloth according to claim 1, wherein the cloth is yellow in color.

3. A crow repelling cloth according to claim 1, wherein the cloth is black in color.

4. A crow repelling cloth according to claim 2, wherein the cloth is in the form of a ribbon that can be tied to twigs or branches of a fruit tree to keep the crows off the fruit tree.

5. A crow repelling cloth according to claim 2, wherein the cloth is in the form of a ribbon that can be tied to slip-preventing fittings of roofing tiles to keep the crows off a roof of a house.

6. A crow repelling cloth according to claim 2, wherein the cloth is in the form of a tape for surrounding around an orchard to keep the crows off the orchard.

7. A crow repelling cloth according to claim 2, wherein the cloth is in the form of a net for covering a heap of garbage sacks to keep the crows off the garbage sacks.
